(19) United States
(12) Patent Application Publication
(10) Pub. No.: US 2025/0124895 A1
(43) Pub. Date: Apr. 17, 2025

(54) Acoustic Waveguide Grand Piano

(71) Applicant: Joseph Katzenberger, Crawfordsville, IN (US)

(72) Inventor: Joseph Katzenberger, Crawfordsville, IN (US)

(21) Appl. No.: 18/379,092

(22) Filed: Oct. 11, 2023

(51) Int. Cl. G10C 3/06; G10C 1/04; G10H 3/18; H04R 1/02

(52) U.S. Cl. CPC G10C 3/06; G10C 1/04; G10H 3/18; H04R 1/025; G10H 2220/461

(57) ABSTRACT

This invention is an acoustic piano with four internal waveguides built into the piano body. Each waveguide is approximately ten feet long. The acoustic sound of the piano is captured by a microphone, a piezo pickup, a pressure transducer pickup, a magnetic pickup under the strings, or any combination of these. It is then sent to an internal electronics package, including an amplifier and an equalizer, which sends the signal to full range speakers. These speakers are mounted at the start of each waveguide and/or inside the waveguide. The sound then travels through each waveguide, which increases in size, similar to a horn, toward the end of the waveguide. One quarter wavelength of the lowest frequency is captured, and directed to multiple sound ports toward the end of the waveguides. The materials being considered for this piano are Maple, Walnut, Rosewood, Mahogany, Ebony, Sitka Spruce and Baltic Birch.

### BACKGROUND OF INVENTION

This solves the problem of a grand piano, or any other acoustic piano not having enough volume, in an acoustic environment, especially with other instruments. My product is made to produce an acoustic, pure, beautiful sound, not needing external amplification or an electrical source (battery powered). That said, an external amplifier can be used, all options are included in this design.

The waveguides are inside the piano, and can't be seen (except multiple ports). The piano does not look any different from a standard piano on the outside. It is radically different on the inside. It is heavier, so this difference may be noticed. The waveguides grow exponentially, and they are manufactured from fine tonewood. This piano has an upper and lower internal chamber. The chamber divider itself encloses the waveguide shape. Everything above the chamber divider is the upper chamber. This is where the pickups can be placed, to capture the true acoustic sound of the piano. The most efficient way this can be manufactured is with computer numerical control programming and machining. A Piano Maker with standard piano building tools may not be able to build this piano completely. That said, a Piano Maker is required to fit, hand work and assemble this piano, to assure the highest levels of quality. This is a true combination of technology and craftsmanship. The goal is to build an acoustic piano with increased volume, so the piano player can easily play/vibrate the strings, resulting in a beautiful rich tone, not degraded by excessive force on the keys or strings. The waveguides greatly contribute to superior sound due to concentrated sound waves. This produces a beautiful sound without losing sound wave energy, and increasing sound wave direction as it exits the piano. It should be noted that all sound normally generated from the soundboard of the piano remains, and is actually enhanced. This is all possible while being UNPLUGGED.

This piano has been completely prototyped as a virtual design (complete digital 3D computer aided design, available for view upon request). The goal is to license this idea to people that understand piano building, or sell it to an established piano manufacturer that can produce this product.

### SUMMARY OF INVENTION

This is a grand piano, or any other acoustic piano that produces much higher volume and improved tone at this higher volume, due to capturing one quarter wavelength of the lowest frequency, while being played with much less effort. This can be achieved with batteries, or plugged in as an option. Piano players all over the world love to control the volume without cumbersome electrical equipment. This piano has two channels, allowing piano playing and singing through the piano simultaneously, for songwriters and performers to take advantage of at any time. This Piano can also be used as a stereo, as any smartphone can be plugged into the piano electronics, and played through the piano waveguides, which greatly boosts volume, and significantly improves the tone of any smartphone. This also allows the piano player the option to play along with their favorite songs on the smartphone, with headphones also an option. This piano has been redesigned many times, due to learning from previous musical instrument builds. Also considered are tonewood conditions such as kiln drying, adhesive strength of bond, water absorption, warping, and stability during machining. Wood conditions for fitting, screwing, doweling, sanding, staining and polishing have also been considered, tested and improved.

### DRAWINGS OF INVENTION

Manufactured components of this instrument are detailed in drawings, and are available for review. This product is modeled in a 3D CAD system for design, and computer numerical controlled (CNC) manufacturing. Components can be programmed from this solid model for manufacturing. This project considers design for manufacturing (DFM) methods, to eliminate redesign during manufacturing.

### BRIEF DESCRIPTION OF THE DRAWINGS

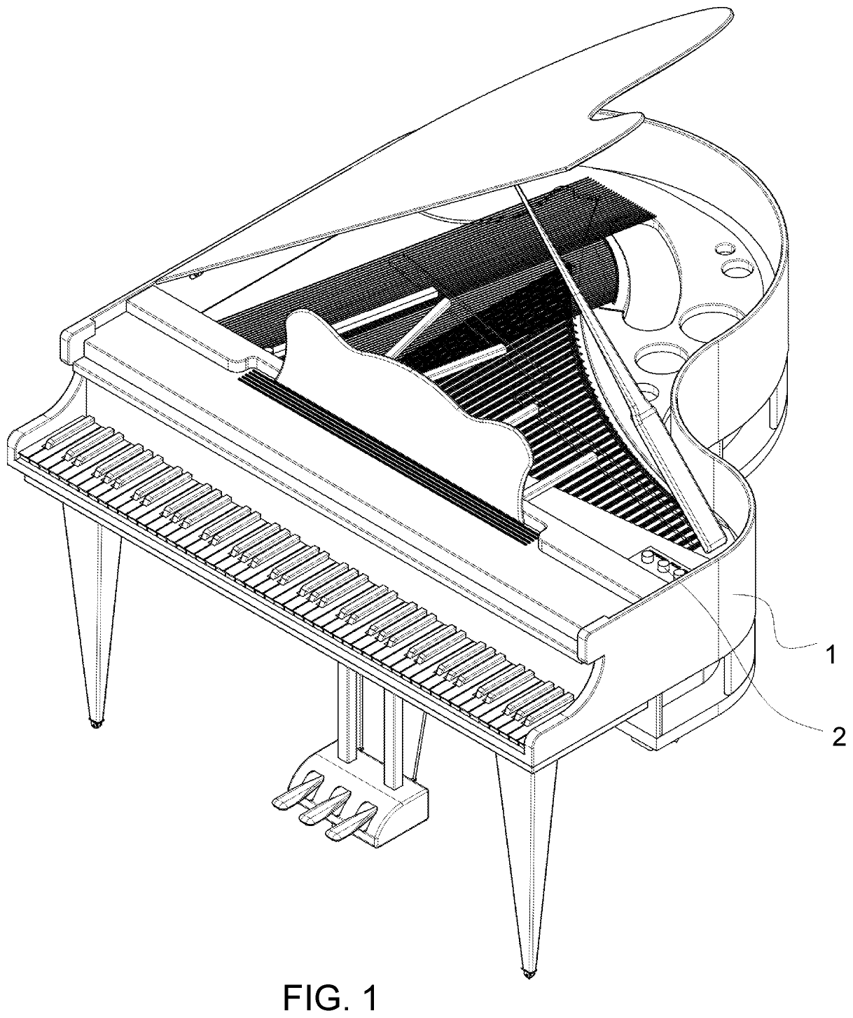

FIG. 1—Complete assembly, isometric top view (sheet 1).

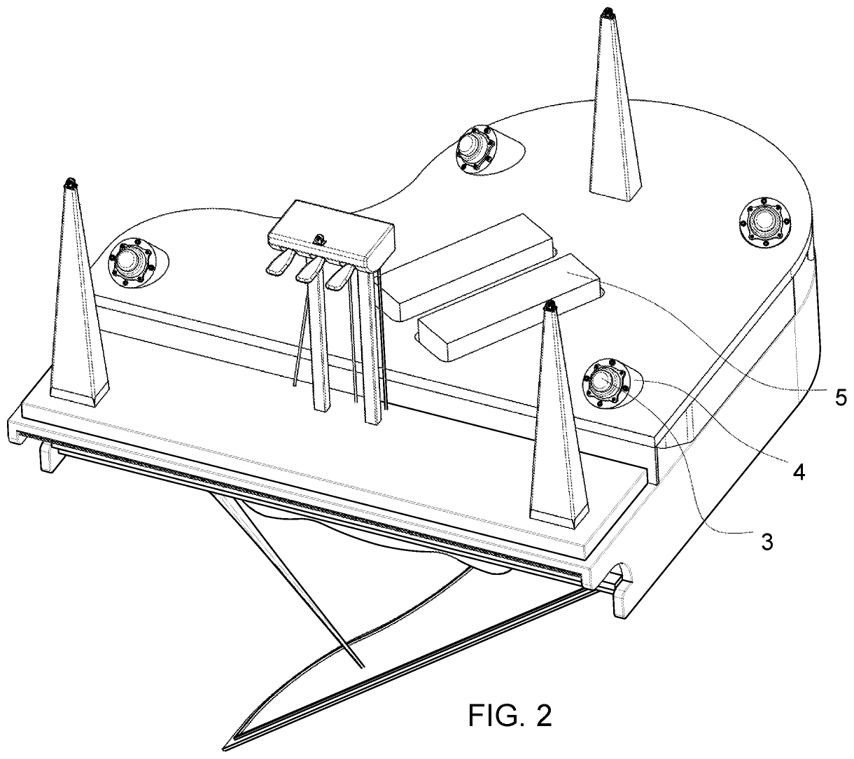

FIG. 2—Complete assembly, isometric bottom view (sheet 2).

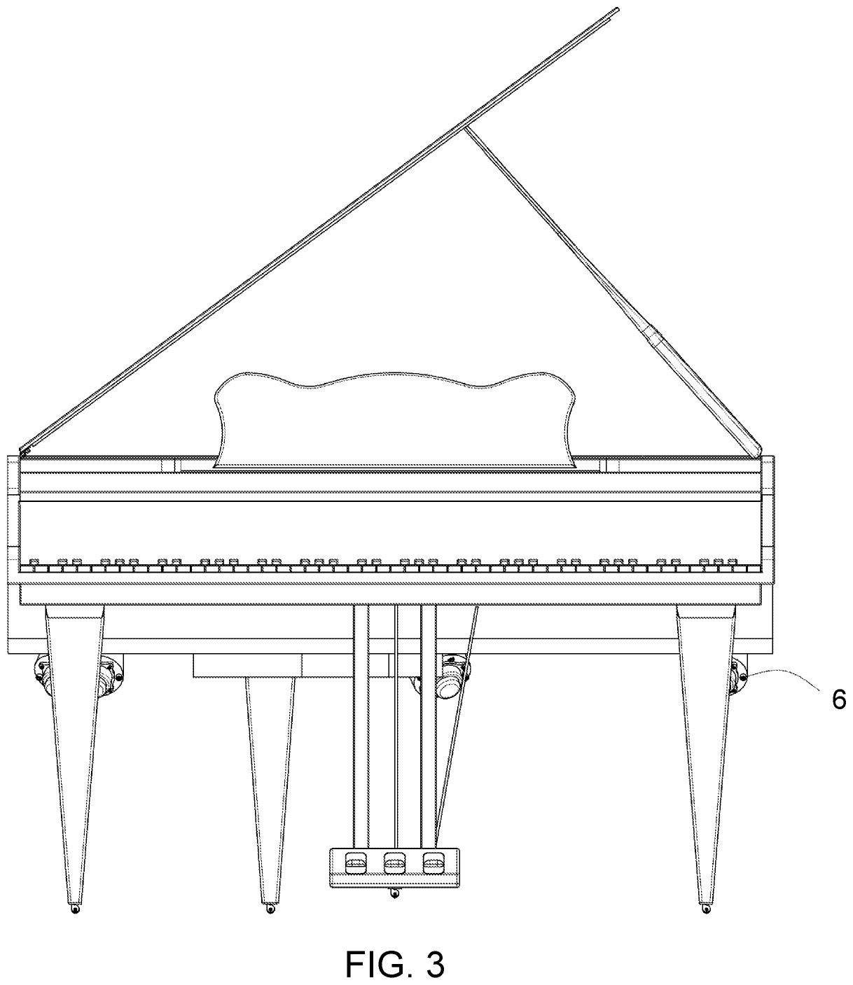

FIG. 3—Complete assembly, front view (sheet 3).

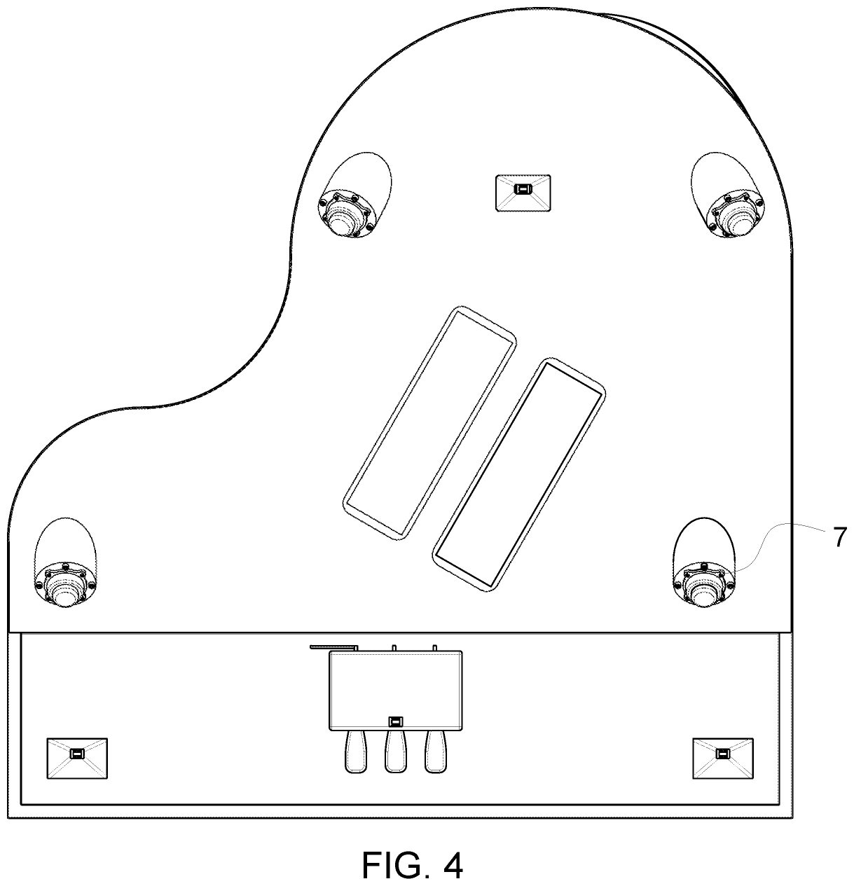

FIG. 4—Complete assembly, bottom view (sheet 4).

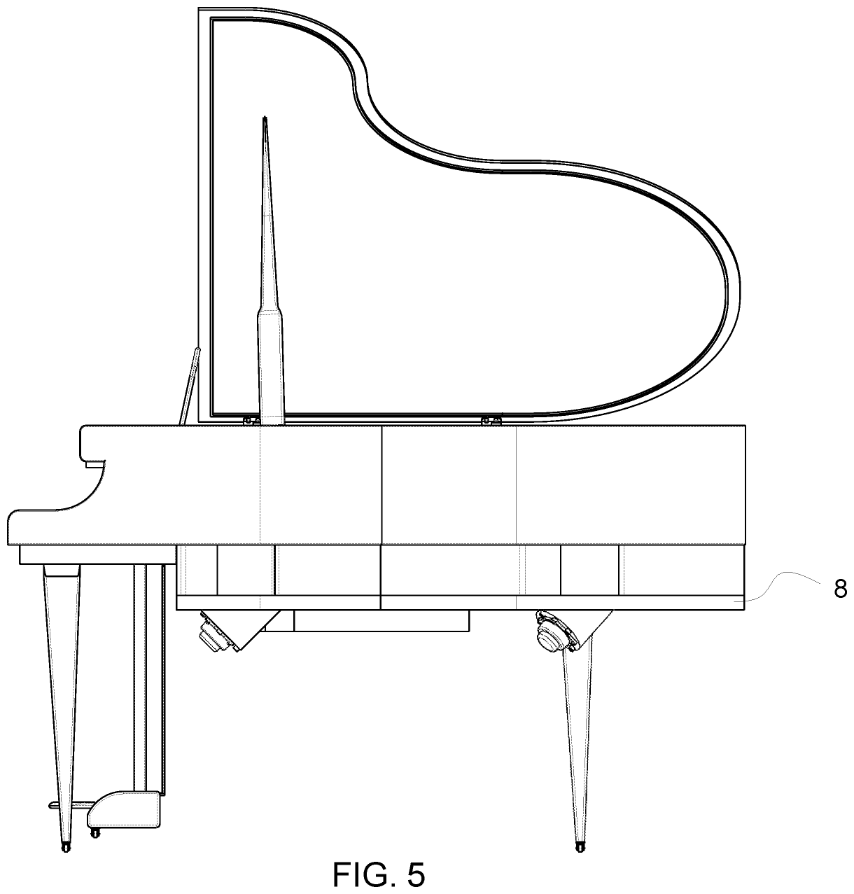

FIG. 5—Complete assembly, side view (sheet 5).

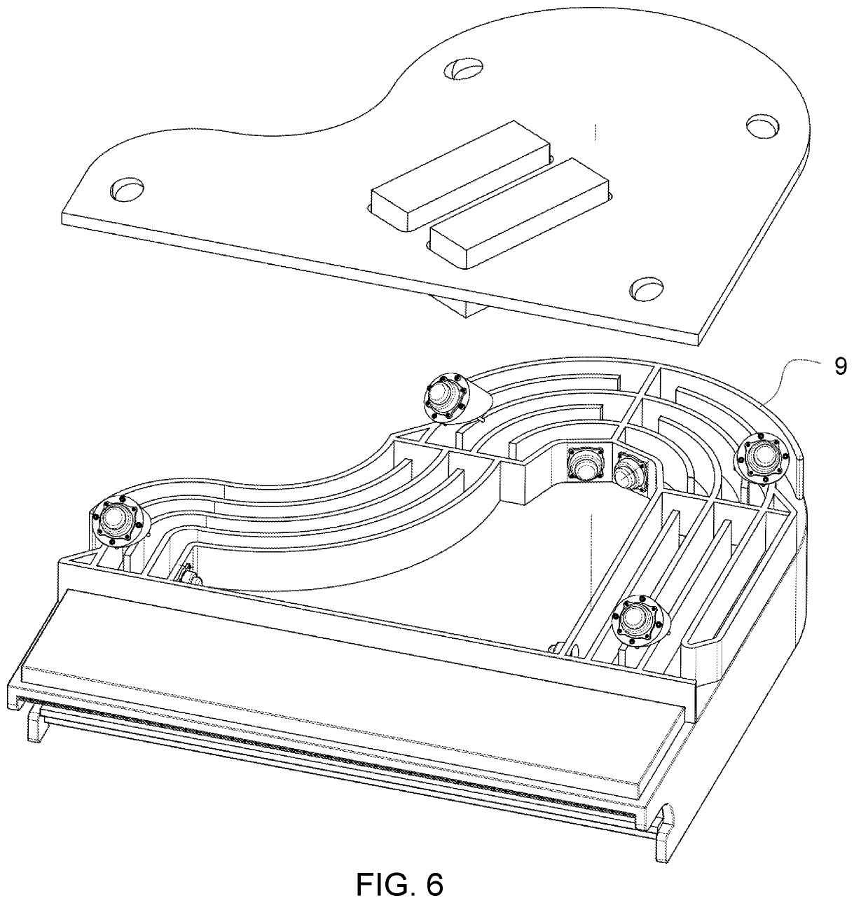

FIG. 6—Partial assembly, isometric exploded bottom view (sheet 6).

### DETAILED DESCRIPTION

Referring now to the drawings: FIG. 1 shows the piano isometric top view, and illustrates an acoustic waveguide grand piano with a bottom, a side, a top, and a soundboard all manufactured from solid wood to form a grand piano body 1. It also shows a pickup system 2, which can be plugged into an amplifier. Also shown are piano strings, keys, frame, pedals and legs. All components have been reviewed for DFM (design for manufacturing), so the machining process does not have any unknown complications.

FIG. 2 shows the piano isometric bottom view, which includes a multitude of speakers 3, a multitude of speaker mounting enclosures 4, and one or more amplifiers, 5.

FIG. 3 shows the piano front view for clarity, and also includes a multitude of speaker mounting enclosure screws, 6.

FIG. 4 shows the piano bottom view for clarity, and also shows a multitude of speaker mounting screws, 7.

FIG. 5 shows the piano side view for clarity, and also shows the waveguide bottom structure, 8.

FIG. 6 shows the piano exploded isometric bottom view, showing the entire waveguide structure 9, which is constructed from multiple pieces of wood.

I claim:

1. An acoustic piano, comprising: a bottom, a side, a top, and a plurality of internal waveguides, constructed from wood to form a piano body;
an internal chamber divider attached to said piano body;
a plurality of external or internal speakers, attached mechanically to said piano body, attached electronically to an internal electronics package, and a plurality of pickups;
said plurality of pickups attached to said internal chamber divider, or said piano body;
said internal electronics package attached to said piano body;
a keyboard attached to said piano body;
a light yet strong soundboard attached to said piano body;
a bridge attached to said light yet strong soundboard;
a piano string set attached to said bridge;

2. The acoustic piano of claim 1, wherein said piano body includes openings allowing sound to travel from said plurality of external or internal speakers into said plurality of internal waveguides.

3. The acoustic piano of claim 1, wherein said internal chamber divider fits on top of said internal waveguides of said piano body, providing a passage for said sound from said plurality of external or internal speakers, preventing loss of said sound, due to said sound containment through said internal waveguides, to outside environment.

4. The acoustic piano of claim 1, wherein said internal electronics package is battery powered, or plugged into power source, and is accessible from said bottom of said acoustic piano.

5. The acoustic piano of claim 1, wherein said plurality of pickups and said internal electronics package provides said sound output through said plurality of external or internal speakers and said internal waveguides.

6. The acoustic piano of claim 1, wherein said light yet strong soundboard is attached to said piano body, with an adhesive or screws, comprising: said light yet strong soundboard constructed from multiple pieces of wood, allowing said light yet strong soundboard to be configured with strong ribs, which provides light weight and increased strength, resulting in increased vibration and a greater amount of air displacement, which increases volume.
